(19) United States
(12) Patent Application Publication
(10) Pub. No.: US 2023/0072524 A1
(43) Pub. Date: Mar. 9, 2023

(54) METHOD AND APPARATUS FOR HANDLING CONTENTION BASED DATA TRANSMISSION IN A WIRELESS COMMUNICATION NETWORK

(71) Applicant: SAMSUNG ELECTRONICS CO., LTD., Suwon-si (KR)

(72) Inventors: Neha SHARMA, Bangalore (IN); Vikalp MANDAWARIA, Bangalore (IN)

(21) Appl. No.: 17/891,982

(22) Filed: Aug. 19, 2022

Related U.S. Application Data
(63) Continuation of application No. PCT/KR2022/012429, filed on Aug. 19, 2022.

(30) Foreign Application Priority Data
Aug. 21, 2021 (IN) 202141037950
Aug. 1, 2022 (IN) 202141037 950

(51) Int. Cl. H04L 1/18; H04W 74/08; H04L 5/00

(52) U.S. Cl. CPC H04L 1/1874; H04W 74/08; H04L 1/1812; H04L 1/1887; H04L 5/0055; H04L 1/189

(57) ABSTRACT

A method for handling contention based data transmission (CBDT) in a wireless communication network is disclosed. The method includes: allocating CBDT resource blocks to a plurality of user equipment (UEs); receiving data bits and control bits on one or more resource blocks among the allocated CBDT resource blocks from a group of UEs among the plurality of UEs; determining whether each of the received data bits and control bits is decoded successfully; transmitting a negative acknowledgment message to each UE in the group of UEs based on determining that the received control bits are decoded successfully, and the received data-bits are not decoded successfully; and storing the data-bits which are not decoded successfully in a hybrid automatic repeat request (HARQ) buffer.

### CROSS REFERENCE TO RELATED APPLICATIONS

This application is a continuation of International Application No. PCT/KR2022/012429 designating the United States, filed on Aug. 19, 2022, in the Korean Intellectual Property Receiving Office and claiming priority to Indian Provisional Patent Application Serial No. 202141037950 (PS), filed on Aug. 21, 2021, in the Indian Patent Office, and to Indian Complete Patent Application Serial No. 202141037950 (CS), filed on Aug. 1, 2022, in the Indian Patent Office, the disclosures of all of which are incorporated by reference herein in their entireties.

### BACKGROUND

### Field

The disclosure relates to wireless communication systems and, for example, to a method and apparatus for handling based data transmission. More specifically the disclosure relates to handling Hybrid Automatic Repeat Request (HARQ) and retransmission in shared resources mechanism for 6^{th} Generation (6G) system.

### Description of Related Art

In recent years, several broadband wireless technologies have been developed to meet the growing number of broadband subscribers for providing better applications and services. Second generation wireless communication system has been developed to provide voice services while ensuring the mobility of users. Third generation wireless communication system supports not only the voice service but also data service. In recent years, fourth wireless communication system has been developed to provide high-speed data service. However, currently, the fourth generation (4G) wireless communication system suffers from a lack of resources to meet the growing demand for high-speed data services. This problem is addressed by the deployment of fifth generation wireless communication system to meet the ever-growing demand for high-speed data services. Furthermore, the fifth generation (5G) wireless communication system provides ultra-reliability and supports low latency applications.

For the sixth generation of wireless communication systems e.g., 6G, various technologies have been under consideration, for example, Visible Light Communication (VLC), Terahertz band (THz) e.g., frequencies from 100 GHz to 3 THz, Infrared wave, and Ultraviolet wave, non-terrestrial network, and Unmanned Aerial Vehicle (UAV), etc. Among all the technologies, the THz band is envisioned as a potential technology for a diverse range of applications, which exist within the nano, micro as well as macro scales. The various features of THz band are such as it may provide terabits per second (TBPS) data rates, reliable transmission, and minimal latency.

The frequencies from 100 GHz to 3 THz are promising bands for the next generation of wireless communication systems because of the wide range of the unused and unexplored spectrum. The THz band communication system also may have revolutionary applications in the realm of devices, circuits, software, signal processing, and systems. The ultra-high data rates facilitated by mmWave, and THz wireless local area and cellular networks enable super-fast download speeds for computer communication, autonomous vehicles, robotic controls, information shower, high-definition holographic gaming, entertainment, video conferencing, and high-speed wireless data distribution in data centers. In addition to the extremely high data rates, THz band communication system also may have applications for future mm Wave and THz systems that are likely to evolve in 6G networks, and beyond.

Another important use case area in the 6G is to promote ubiquitous and high-capacity global connectivity. Non-Terrestrial Network (NTN) is a key research area that can provide high-capacity connectivity in future 6th generation (6G) wireless networks. The Non-Terrestrial Networks (NTN) are expected to foster the roll out of 6G/B5G service in un-served areas that cannot be covered by a terrestrial network (isolated/remote areas, onboard aircrafts or vessels) and underserved areas (e.g., sub-urban/rural areas) to upgrade the performance of limited terrestrial networks in cost effective manner. They will impact coverage, user bandwidth, system capacity, service reliability or service availability, energy consumption, and connection density. The NTN includes spaceborne as well as airborne networks. The spaceborne network includes GEO (geostationary), LEO (low earth orbit), and MEO (medium earth orbit) satellites while access network based on Unmanned Aerial System (UAS) including High Altitude Platform Station (HAPS) could be considered as a special case of non-terrestrial access with lower delay/Doppler value and variation rate. The NTN network which is based on satellites and UAS or HAPS can be used to improve the coverage as well as improve the capacity of the system.

FIG. 1 is a diagram illustrating a system (100) depicting a basic scenario where a non-terrestrial network is providing access to a User Equipment (UE), according to a conventional state of art. The non-terrestrial network refers to a network or segment of networks using RF resources on board a satellite (or UAS platform) 101. As per TR 38.821, the Non-Terrestrial Network typically features one or several sat-gateways (e.g., gateway 103) that connect the Non-Terrestrial Network to a public data network 105. A GEO satellite is fed by one or several sat-gateways which are deployed across the satellite targeted coverage (e.g., regional, or even continental coverage). Assuming that the user equipment (UE) 107 in a cell is served by only one sat-gateway. A Non-GEO satellite is served successively by one or several sat-gateways at a time. The system ensures service and feeder link 109 continuity between the successive serving sat-gateways with sufficient time duration to proceed with mobility anchoring and hand-over. The Feeder link 109 is a radio link between a sat-gateway and the satellite 101. A radio link that connects the user equipment and the satellite 101 is called a service link 111. The satellite 101 may implement either a transparent or a regenerative (with on board processing) payload. The satellite 101 typically generates several beams over a given service area bounded by its field of view 113. The footprints of the beams 115 are typically of elliptic shape. The field of view 113 of the satellite depends on the on-board antenna diagram and minimum elevation angle. A transparent payload has Radio Frequency filtering, Frequency conversion, and amplification. Hence, the waveform signal repeated by the payload is unchanged.

A regenerative payload has radio frequency filtering, frequency conversion, and amplification as well as demodulation/decoding, switch and/or routing, and coding/modulation. This is effectively equivalent to having all or part of the base station functions (e.g., gNB) on board the satellite 101. Inter-satellite links (ISL) optionally in case of a constellation of satellites. This will require regenerative payloads on board the satellites. The ISL may operate in RF frequency or optical bands. The UE 107 is served by the satellite 101 within the targeted service area and there may be different types of satellites (or UAS platforms) listed in Table 1 as shown below:

TABLE 1

| NTN scenarios | | | | | |
|---|---|---|---|---|---|
| A | B | C1 | C2 | D1 | D2 |

| | GEO | GEO | LEO | LEO |
|---|---|---|---|---|
| | transparent | regenerative | transparent | regenerative |
| | payload | payload | payload | payload |
| Satellite altitude | 35786 km | | 600 km | |
| Relative speed of Satellite | negligible | | 7.56 km per second | |
| with respect to earth | | | | |
| Min elevation for both | 10° for service link and 10° for feeder link | | | |
| feeder and service links | | | | |
| Typical Min/Max NTN | 100 km/3500 km | | 50 km/1000 km | |
| beam foot print diameter | | | | |
| (note 1) | | | | |
| Maximum propagation delay | 541.46 ms | 270.73 ms | 25.77 ms | 12.89 ms |
| contribution to the Round | (Worst | | | |
| Trip Delay on the radio | case) | | | |
| interface between the gNB | | | | |
| and the UE | | | | |
| Minimum propagation delay | 477.48 ms | 238.74 ms | 8 ms | 4 ms |
| contribution to the Round | | | | |
| Trip Delay on the radio | | | | |
| interface between the gNB | | | | |
| and the UE | | | | |

The propagation delay or Max Round Trip Delay may refer to the amount of time the signal takes to travel from the transmitter side to the receiver side. In terrestrial mobile systems timing advance is very fewer ˜μs as a result propagation delay is almost zero (Timing advance: (2*prop_delay)). In contrast, the propagation delays in NTN are much longer, ranging from several milliseconds (ms) to hundreds of milliseconds depending on the altitudes of the spaceborne or airborne platforms and payload type in NTN. As an example, the propagation delay ranges for the transparent payload: service and feeder links are 25.77 (600 km) and 41.77 ms (1200 km) for LEO satellites, for GEO it is 541.46 ms (service and feeder links) and 270.73 ms (service link only). While dealing with such long propagation delays requires modifications of many timing aspects in NR from the physical layer to higher layers, including the timing advance (TA) mechanism, measurement, Channel Quality Indicator (CQI), HARQ procedure, scheduling, etc.

Further, the use of HARQ in 5G NR benefits URLLC and eMBB use cases. HARQ typically achieves a residual error rate of 0.1-1%. Better performance can be achieved but at the cost of increased feedback signaling, higher power, or lower spectral efficiency. In Non-Terrestrial Networks (NTNs), HARQ operation is a challenge due to Round-Trip time in the order of hundreds of milliseconds.

Further, in non-terrestrial networks, the drawback of the scheduling procedure is that it would take at least 2 round-trip times from data arriving in the buffer at the UE side until it can be properly scheduled with resources that would fit the data and the required Quality of Service (QoS). Due to the large propagation delays, this may become prohibitively large. The large propagation delay can further increase the scheduling delay which can impact the user experience. Contention based data transmission (CBDT), or shared resource mechanism is a scheme that is used in a case where few physical resources or grants can be reserved by the network for data transmission and shared with all the UEs. These resources can be used by any of the UE as required. If multiple UEs try to use the same set of resources, then it may lead to an occurrence of contention on the Network side. An example of such a scheduling procedure is shown in FIG. 2 of the drawings, according to conventional art.

FIG. 2 is a diagram illustrating an example scenario where the network provides the contention-based grants to the UE, in accordance with the conventional art. In this scheme, the network 201 provides the contention-based grants to the UE which are shared resources (e.g., CBDT resources 203). When any UE (e.g., UE 205) receives any data, it first checks whether any CBDT related resources are available if yes, then it selects these resources and sends data and the SR e.g., scheduling resource to the network 201. The SR is required in case where the contention has occurred. Thereafter, the network 201 may send the grants to the UE 205 to send the BSR. Once network 201 receives the BSR, it may check whether any contention has occurred or not as multiple UEs may use the same set of resources. If it is determined that there is no contention, then the network 201 may send ACK to the UE. If it is determined that the contention has occurred, then the multiple UE may try to use the same resources. Thereafter, the network 201 may send the grants to the UE 205 so that the UE 205 may send the BSR (Buffer status report). In view of the above explained scenario of FIG. 2, it is determined that in any case if any contention will occur then it should fall back to normal scheduling procedure as per the conventional art, where at first the UE sends the BSR and then the NW after receiving the BSR, allocates the grants to the UE to send the data. This Contention is one of the major issues which can occur at the network side when multiple UEs try to use the same set of resources.

Therefore, in order to provide continuous communication service through UAVs, there lies a need for a method and system that can handle the HARQ and retransmission for shared resources to provide a seamless user experience for the 6G cellular system.

### SUMMARY

According to an example embodiment, the present disclosure describes a method for handling contention based data transmission (CBDT) in a wireless communication network. The method includes: allocating CBDT resource blocks to a plurality of user equipment (UEs); receiving data bits and control bits on one or more resource blocks among the allocated CBDT resource blocks from a group of UEs among the plurality of UEs; determining whether each of the received data bits and control bits is decoded successfully; transmitting a negative acknowledgment message to each UE in the group of UEs based on determining that the received control bits are decoded successfully, and the received data-bits are not decoded successfully; and storing the received data-bits which are not decoded successfully in a hybrid automatic repeat request (HARQ) buffer.

According an example embodiment, the present disclosure describes a network entity for handling contention based data transmission (CBDT). The network entity include a communication interface comprising communication circuitry and at least one processor coupled to the communication interface. The at least one processor is configured to: allocate CBDT resource blocks to the plurality of UEs; receive data bits and control bits on one or more resource blocks among the allocated CBDT resource blocks from a group of UEs among the plurality of UEs; determine whether each of the received data bits and control bits is decoded successfully; and transmit a negative acknowledgment message to each UE in the group of UEs based on determining that the received control bits are decoded successfully, and the received data-bits are not decoded successfully; and store the received data-bits which are not decoded successfully in a hybrid automatic repeat request (HARQ) buffer.

To further clarify the advantages and features of the present disclosure, a more particular description will be rendered by reference to specific example embodiments thereof, which are illustrated in the appended drawings. It is appreciated that these drawings depict example embodiments of the disclosure and are therefore not to be considered limiting its scope. The disclosure will be described and explained with additional specificity and detail with the accompanying drawings.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a system diagram depicting a basic scenario where a non-terrestrial network is providing access to a UE, according to a conventional state of art;

FIG. 2 is a diagram illustrating an example scenario where the network provides the contention-based grants to the UE, according to the conventional art;

FIG. 3 is a diagram illustrating an example of a communication system, according to various embodiments;

FIG. 4 is a flowchart illustrating an example method for handling ACK/NACK for shared resource mechanism where the NW entity identifies the UE, according to various embodiments;

FIG. 5 is a diagram illustrating an example of network contention caused by multiple UEs using a same set of shared resources at a same time in case of a share scheduling mechanism, according to various embodiments;

FIG. 6 is a flowchart illustrating an example method for handling ACK/NACK for shared resource mechanism where the NW entity identifies the UE based on control bits, according to various embodiments;

FIG. 7 is a flowchart illustrating an example method for handling ACK/NACK for shared resource mechanism where the NW entity identifies the UE based on control bits, according to various embodiments;

FIG. 8 is a block diagram illustrating an example configuration of the master NW Entity of FIG. 3, according to various embodiments; and

FIG. 9 is a block diagram illustrating an example configuration of the UE of FIG. 3, according to various embodiments.

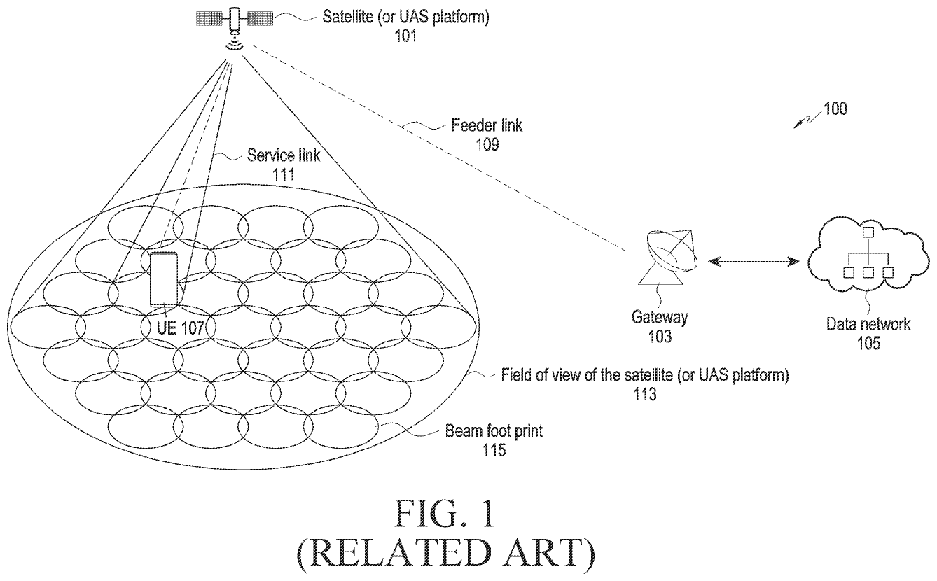

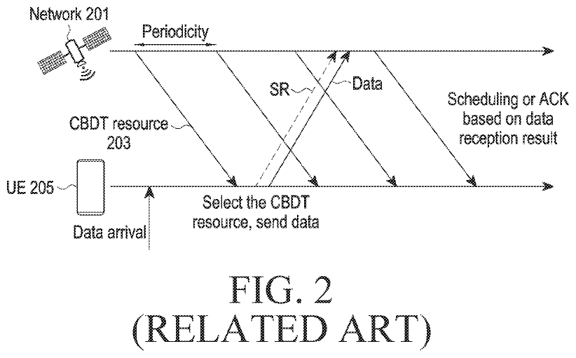

Further, skilled artisans will appreciate that elements in the drawings are illustrated for simplicity and may not have necessarily been drawn to scale. For example, the flowcharts illustrate various methods in terms of operations involved to help to improve understanding of aspects of the present disclosure. Furthermore, in terms of the construction of the device, one or more components of the device may have been represented in the drawings by conventional symbols, and the drawings may illustrated details pertinent to understanding the various example embodiments of the present disclosure and to not obscure the drawings with details that will be readily apparent to those of ordinary skill in the art having the benefit of the description herein.

### DETAILED DESCRIPTION

It should be understood that although illustrative implementations of the various example embodiments of the present disclosure are illustrated below, the present disclosure may be implemented using any number of techniques, whether currently known or in existence. The present disclosure is not necessarily limited to the illustrative implementations, drawings, and techniques illustrated below, including the example design and implementation illustrated and described herein, but may be modified within the scope of the present disclosure.

It is to be understood that as used herein, terms such as, “includes,” “comprises,” “has,” etc. are intended to refer, for example, to the one or more features or elements listed being within the element being defined, but the element is not necessarily limited to the listed features and elements, and that additional features and elements may be within the meaning of the element being defined.

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element unless otherwise specified by limiting language such as “there needs to be one or more . . . ” or “one or more element is required.”

Unless otherwise defined, all terms, and especially any technical and/or scientific terms, used herein may be taken to have the same meaning as commonly understood by one having ordinary skill in the art.

Some components are exaggerated, omitted, or schematically illustrated in the accompanying drawings. As such, the size of each component does not fully reflect the actual size.

In each figure, the same or corresponding elements may be assigned the same reference numerals.

Each block in the flowcharts may represent part of a module or segment. The functions described in the blocks may occur out of the order noted in the drawings. For example, two blocks illustrated in succession may be executed substantially concurrently, or the blocks may sometimes be executed in reverse order, depending on the functions involved therein.

For the convenience of description, the present disclosure includes terms and names defined in LTE and new radio (NR) standards defined by the 3GPP group. However, the present disclosure is not limited by the terms and names and may be equally applied to other systems conforming to other standards.

According to an embodiment of the present disclosure, for HARQ with CBDT, UE identification is required at the network (NW) side with CBDT transmission. The present disclosure provides a mechanism in which UE identification happens at the NW side when contention occurs for shared resources. The NW may be configured to send an indication to all UEs that contention has happened and take necessary actions.

Multiple UEs may be using the same set of shared resources. There are high chances that some of the UEs may end up using the same set of shared resources. The data may successfully reach at the NW but due to contention, the NW may be failed to decode. In NR, asynchronous HARQ is agreed for uplink data transmission. In this case, NW may not send explicit HARQ feedback but through an NDI bit, UE can determine whether the transmission is successful or not. If the NDI bit is toggled, then there is a need to perform new transmission and if it is not toggled then retransmission needs to be performed. This kind of HARQ-ACK feedback mechanism can help to reduce the signalling overhead compared with explicit HARQ feedback.

If the CBDT control resource blocks (RBs) or shared resources are decoded successfully, the NW may decode the data transmitted by the UEs on shared resources based on any of the above methods. Once the NW receives it successfully and decodes the same there will be no explicit HARQ feedback, but the NDI bit may be used to indicate whether a new transmission should be performed (by a toggled NDI bit). The NW may be configured to assign dynamic grants or shared grants for the same HARQ process.

If the NW may not be able to decode the CBDT control RBs or shared resources, it could be due to a contention issue or due to poor radio condition. In both cases, the NW may send the NACK to the UEs. Further, in such a case there is need for identification arises at the UE whether the NACK has come due to poor radio condition or any decoding errors, or contention issues. Both the cases required different handling else UE will end up in either retransmission or flush the HARQ buffer results e.g., loss of data packet.

Various example embodiments of the present disclosure will be described in greater detail below with reference to the accompanying drawings.

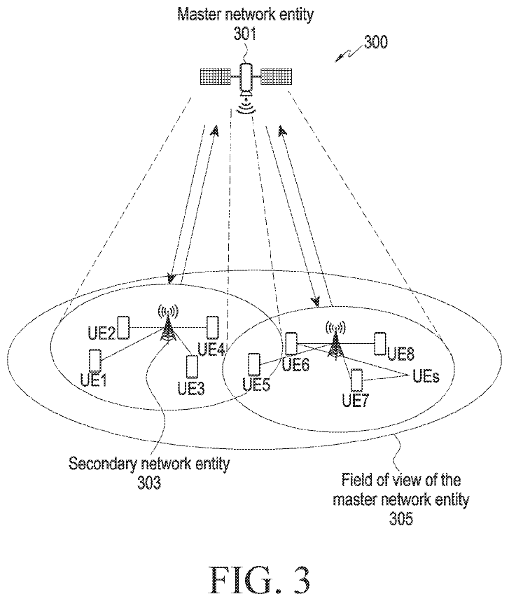

FIG. 3 is a diagram illustrating an example of a communication system, according to various embodiments. The communication system includes a master Network (NW) Entity 301, a secondary NW entity 303, and a plurality of UEs within a field of view 305 of the Master NW Entity 301 (as a non-limiting example, UEs 1, 2, 3, 4, 5, 6, 7 and 8 (which may be referred to as UEs 1 to 8) within the field of view 305 of the Master NW Entity 301). The master NW Entity 301 is configured to perform a communication procedure between the components of the communication system using a communication interface. The plurality of UEs of the communication system is configured to communicate with the master NW Entity 301 via the secondary NW entity 303 as a communication medium. In the present disclosure, the master NW entity 301 may control the operations of the communication system required for handling the CBDT.

For example, the master NW Entity 301 may correspond to one of a network, but is not limited to, a network such as LTE, NR entity, MCG or SCG link, HAPS, satellite, ground network, moving network, or Core Network (NW) and may be configured to handle the HARQ and retransmission for shared resources to provide a seamless user experience for the 6G cellular system. The master NW Entity 301 may include but is not limited to, a Core NW, a satellite controller, etc.

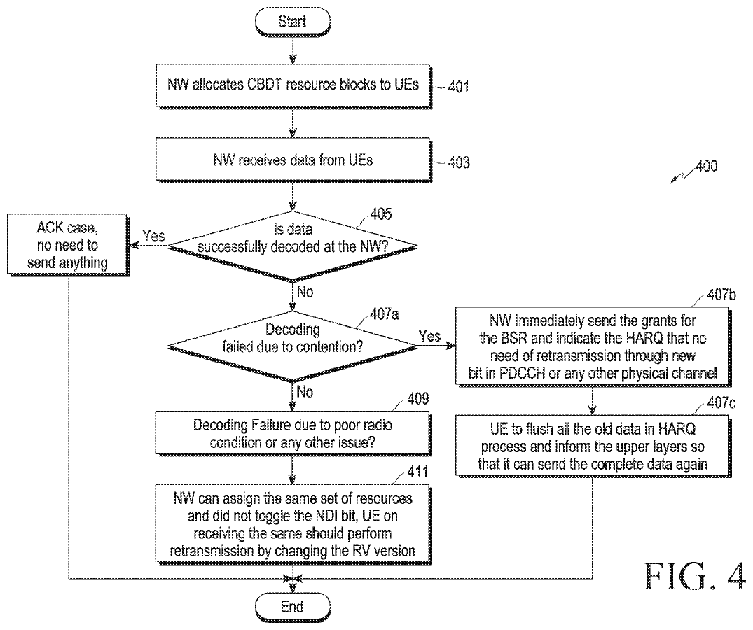

A description of various functionalities of the communication system will be described in greater detail below with reference to FIGS. 4, 6, and 7.

FIG. 4 is a flowchart illustrating an example method to handle ACK/NACK for shared resource mechanism where NW identifies the UE, according to various embodiments. For example, FIG. 4 illustrates an example method 400 which illustrates a signaling procedure between the master NW Entity 301 and the plurality of UEs within the field of view 305 of the Master NW Entity 301.

At 401 of the method 400, the master NW Entity 301 allocates CBDT resource blocks to the UEs for receiving data including data bits and control bits. As a non-limiting example, the master NW Entity 301 allocates CBDT resource blocks allocates CBDT resource blocks to the UEs 1 to 8 within the field of view 305 of the master NW Entity 301. The CBDT resource blocks are allocated to each of the UEs with one or more identifiers. The one or more identifiers may include, but are not limited to, at least one of a shared Radio Network Temporary Identifier (SH RNTI), a Contention Based Data Transmission Radio Network Temporary Identifier (CBDT RNTI), and an X-CRNTI.

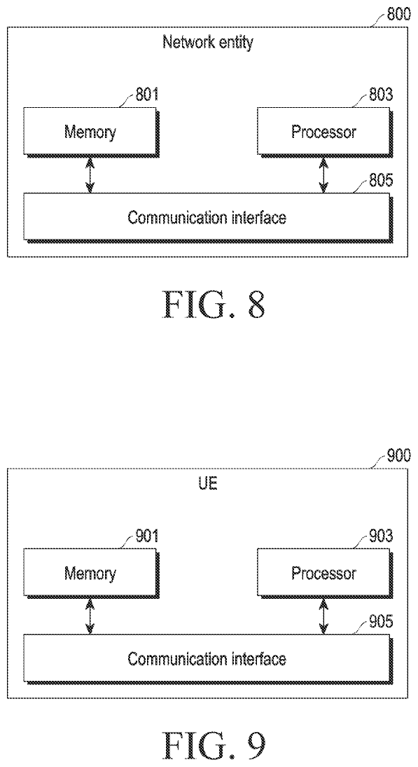

According to an embodiment of the present disclosure, the master NW Entity 301 may transmit the allocated CBDT resource blocks to the UEs with at least one identifier among the one or more identifiers in a Radio Resource Control (RRC) message using a communication interface (shown in FIG. 8).

At 403, the master NW Entity 301 receives, via the communication interface in response to the transmitted CBDT resource blocks, data including the data bits and control bits on one or more resource blocks among the allocated CBDT resource blocks from a group of UEs among the plurality of UEs. As a non-limiting example, the master NW Entity 301 receives data including the data bits and control bits on one or more allocated CBDT resource blocks from one or more UEs that are present in the field of view 305 of the master NW Entity 301. Each of the received control bits and the data bits may be masked with at least one identifier among the one or more identifiers, and the master NW Entity 301 may identify each UE within the group of UEs from which the data including control bits and the data bits are received, with help of the least one identifier with which the received control bits and the data bits are masked.

At 405, the master NW Entity 301 may determine whether the received data is decoded successfully. If the result of the determination at 405 is yes, then the master NW Entity 301 may transmit an acknowledgment message to each UE within the group of UEs via the communication interface. In the acknowledgment case, the master NW Entity 301 may be configured not to send anything to the UEs.

However, if a result of the determination at 405 is No, the master NW Entity 301 may transmit, via one of a physical control channel or a data channel in form of Downlink Control Information (DCI), a negative acknowledgment message to each UE in the group of UEs from which the data including the control bits and data bits is received (not shown). The negative acknowledgment message includes information related to failed CBDT resource blocks.

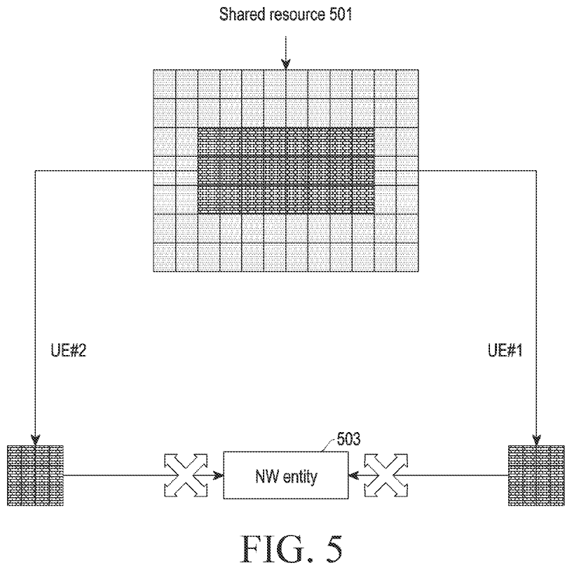

At 407a when the result of the determination at the step 405 is No, the master NW Entity 301 determines whether the decoding of the data failed due to an occurrence of contention for accessing the same resource block by at least two UEs among the UEs in the field of view of the master NW Entity 301. If the result of the determination at the step 407a is yes, the method proceeds to steps 407b and 407c. At 407b the master NW Entity 301 may transmit new data bits indicating at least one of a non-requirement of retransmission of the data for the HARQ process to each UE within the group of UEs. At 407c, the master NW Entity 301 may transmit new data bits indicating a recommendation to flush previously transmitted data associated with the HARQ process and subsequently inform upper layers about the flush of the data so that it can send the complete data again. The new data bits correspond to broadcast bits and can be transmitted to the UEs by the master NW Entity 301 via a physical channel including one of a Physical channel Hybrid ARQ Indicator Channel (PHICH) or Physical Downlink Control Channel (PDCCH). A non-limiting example depicting an occurrence of contention is shown in FIG. 5 of the drawings. For example, FIG. 5 depicts a flow diagram depicting an example of network contention caused by multiple UEs using a same set of shared resources at a same time in case of a share scheduling mechanism.

As illustrated in FIG. 5, Multiple UEs (e.g., UE#1 and UE#2) are using a common shared resource 501, when contention happens at the NW Entity 503 there may be a case where the NW Entity 503 is not able to identify the UE (e.g., UE#1 or UE#2) for which contention happens and also not able to send ACK/NACK to the UE (UE#1 or UE#2). If the NW Entity 503 does not send any indication to the UE till the shared grants and the timer expires, then the UE considers it as an ACK procedure and flushes the data from the HARQ buffer.

According to an embodiment of the present disclosure, the master NW Entity 301 may also toggle New Data Indicator (NDI) bit for the HARQ process when it is determined that the decoding of the data is failed due to the occurrence of contention. The NDI bit for the HARQ process is toggled such that the previously transmitted data associated with the HARQ process is flushed from a HARQ buffer.

However, if the result of the determination at step 407a is No, the method proceeds to (409). At 409, the master NW Entity 301 may determine whether the decoding of the data failed due to poor radio conditions or any other issue. If the result of the determination at step 409 is yes, then the method 400 proceeds to 411. At 411, the master NW Entity 301 may reallocate the CBDT resource blocks to the plurality of UEs and may restrict the toggling of the NDI bit for the HARQ process. The reallocated CBDT resource blocks and the allocated CBDT resource blocks are the same. The UEs on receiving the reallocated CBDT resource blocks may perform retransmission of the data by changing the redundancy version (RV). The UEs may also indicate the RV in UCI for CBDT transmissions. These Multiple HARQ retransmissions may ensure that the success probability for CBDT RBs is increased. During the other cases of NACK, the UEs may be configured to follow the conventional procedure and perform the retransmission until a successful transmission. Another possibility is if there is NACK, the UEs may consider this as an unsuccessful case of sharing resource procedure and fall back to the conventional procedure by sending SR to the master NW entity 301 again.

In view of the above-described operations 407a and 409, the reason for the decoding failure may be the contention issue or the poor radio condition. In both cases, the master NW Entity 301 may send or indicate the NACK to the UEs. The master NW Entity 301 may configure the UEs with new resources to send or indicate the NACK to UEs. Once the UEs transmit the data it starts a timer Txx, which can be configured by the RRC message or can be indicated by a MAC control element or the physical channel. This timer can be configured per bearer, application, or resource allocation scheme like for shared resources. This timer can be configured differently than for the dedicated resource. e.g., on bearers or logical channels of MAC level, there could be separate timers. HARQ timer and a number of HARQ level retransmission can be different for shared we well as dedicated resources. This timer can be configured by both Master cell Group (MCG) and Secondary Cell Group (SCG). In this case, if any UEs receive the new resources before the expiry of the timer then it should retransmit the whole data again and inform the upper layers. The UE should also send a Buffer Status Report (BSR) along with data. Another possibility is once UE sends the data it can start the timer. The timer can be T1 or a shared configured timer, and if the UE gets any new indication till the expiry of the timer it may consider this as a NACK and can try sending data again using the allocated CBDT resource blocks. In case the UE does not get any indication, then it may consider that the decoding of the data is successful.

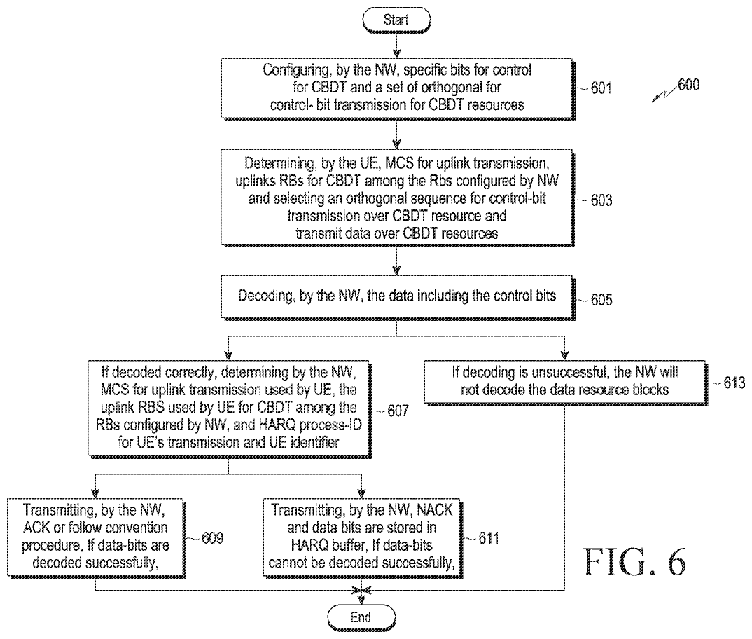

FIG. 6 is a flowchart illustrating an example method for handling ACK/NACK for shared resource mechanism where the master NW entity 301 identifies the UEs based on control bits, according to various embodiments. The method 600 of FIG. 6 may be implemented in the communication system of FIG. 3 particularly in the master NW entity 301. The operations of the method 600 can be performed by a processor included in the master NW entity 301 as shown in FIG. 8 of the drawings. For contention-based uplink data transmission, no uplink grants are available for UE and the master NW entity 301 may have no knowledge of the resources, Modulation Coding scheme (MCS) of data transmission, etc. that may be used by the UE. In an embodiment, blindly decoding for the master NW entity 301 without prior knowledge may be a practically impossible task.

According to the method 600, at 601, the master NW entity 301 may pre-configure specific bits for control for CBDT and a set of orthogonal for control- bit transmission for CBDT resources.

If the UE has data in buffer but no UL grants available, the UE may transmit data on contention-based resources after masking the data with X-CRNTI or any other identifier as mentioned above. At 603, the UE determines the uplink resources, Modulation Coding Scheme (MCS), etc. for contention-based uplink transmission. Besides this, the UE may be configured to randomly select one of the orthogonal sequences pre-configured for control transmission for CBDT resources. The UE may also be configured to perform a series of actions including determining the MCS for uplink transmission, determining Uplink RBs for CBDT among the RBs configured by the master NW entity 301, selecting an orthogonal sequence for control-bit transmission over CBDT resources, and transmitting data over the CBDT resources. Before the transmission, the UE may mask these control bits with a UE identifier e.g., a unique identifier to get uniquely identified by the master NW entity. Thus, according to operation 603, the UE schedules itself (unlike conventional scheduled transmissions). Further, the UE may also decide its own MCS (normally determined by the master NW entity 301 in scheduled transmissions).

At 605, the master NW entity 301 may decode the control bits for CBDT resources upon reception and decode the control bits of UE.

At 607, the master NW entity 301 determines whether the control bits can be decoded correctly. In particular, the master NW entity 301 at first obtains the MCS for uplink transmission used by UE, the uplink RBs used by UE for CBDT among the RBs configured by master NW entity 301, HARQ process-ID for UE's transmission, and UE identifier. Then, the master NW entity 301 determines whether the control bits can be decoded correctly based on these obtained parameters. The control bits may include all these information necessary for the determination.

In case the data received from the UE is decoded correctly at 605, proceeds to 609. At 609, the master NW entity 301 may transmit the ACK message to the UE. The master NW entity 301 may also transmit the resource allocation for transmission of the rest of the data if BSR was also transmitted on the CBDT or shared RBs. Though, if the control bits are decoded successfully and the data-bits are not decoded correctly, NACK can be transmitted by the master NW entity 301 at 611, and the data-bits are stored in the HARQ buffer. The master NW entity 301 can send the NACK indication on any physical channel, on receiving the same UE can inform the upper layers and perform the retransmission another possibility could be retransmissions of HARQ can be done based on resource allocation. Thus, according to the step 611, the master NW entity 301 may decide to maintain data in the HARQ buffer based on successful and unsuccessful decoding at the master NW entity 301 of control bits (self-scheduling information sent by UE).

If the decoding of data is unsuccessful at 605, the method 600 proceeds to 613. At 613, the master NW entity 301 cannot understand which all UEs have transmitted the data. In that case, the master NW entity 301 can simply send the broadcast bits through the physical data channel which indicates the contention has happened.

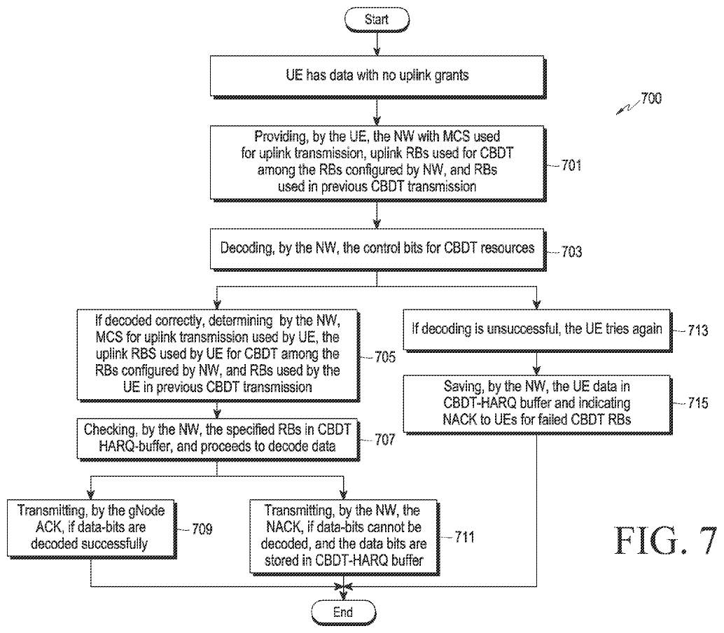

FIG. 7 is a flowchart illustrating an example method for handling ACK/NACK for shared resource mechanism where the master NW entity 301 identifies the UE based on control bits, according to various embodiments. In an embodiment, the master NW entity 301 may configure specific bits for control transmission for CBDT or shared resources and if the UE has data in buffer but no UL grants available, the UE may decide to transmit data on contention-based resources.

Considering that the UE has data with no uplink grants, the method 700, includes determining at 701, by the UE, the uplink resources, MCS scheme, etc for contention-based uplink transmission. The UE may be configured to transmit this information over the control-bits along with the data-bits on CBDT RBs based on a configured shared identifier or any other identifier as mentioned above. If this is not the UE's first attempt for data transmission, the UE may also indicate the RBs used by the UE for data transmission in previous slots which may be in the HARQ buffer of the master NW entity 301.

Upon reception, the method 700 may include decoding at 703, by the master NW entity 301, the control bits for CBDT resources. If the master NW entity 301 is able to decode the control bits correctly the method proceeds to 705. At 705, the master NW entity 301 first obtains the MCS for uplink transmission used by UE, the uplink RBs used by UE for CBDT among the RBs configured by master NW entity 301, HARQ process-ID for UE's transmission, and UE identifier. The master NW entity 301 determines whether the control bits can be decoded correctly based on these obtained parameters. The control bits may include all these information necessary for the determination.

Now based on this indicated information, the method 700 may include checking at 707, by the master NW entity 301, if the data-bits of the specified RBs are in the HARQ buffer. If yes, then the master NW entity 301 may perform HARQ-decoding and performs normal decoding treating UE's transmission as first-time transmission. Thus, if the data is decoded correctly, the method 700 may include transmitting at 709, by the master NW entity 301, ACK to the UE where the master NW entity 301 may also transmit the resource allocation for transmission of the rest of the data if BSR was also transmitted on the CBDT RBs. Though, if the data-bits cannot be decoded correctly, then the method 700 may include storing at 711, the data in the HARQ buffer for CBDT RBs.

Further, if the control-bits were not decoded successfully the method 700 proceeds to 715. The method 700 may include storing, by the master NW entity 301, the data-bits in the HARQ buffer for CBDT resources. If the master NW entity 301 saves UE data in the CBDT-HARQ buffer, then NACK may be indicated to UEs for failed CBDT RBs. This NACK can be sent by the physical control channel or data channel through DCI or UCI bits. It can result in a flush of the data at the master NW entity 301 ends as well as the UE end. The UE may keep on receiving the NACK indication or any other indication bit which signifies transmission is not successful. In case any collision occurs then, the UE should not use the shared resources and use the dedicated resources or next available resources for data transmission. Another possibility is, that if contention occurs on control bits, the UE may be configured to try for the same control bits again until maximum retries are possible which can be configured by the NW entity as shown in 713 of method 700. The UE may also try to select a different set of RBs and sent the control bits again.

Further, according to an embodiment of the present disclosure, the master NW entity 301 may also calculate periodically a transmission probability for each of the UEs for accessing the allocated CBDT resource blocks, in a grant-free (GF) access period. The master NW entity 301 may further transmit, in the RRC message, the periodically calculated transmission probability to each of the UEs along with the allocated CBDT resource blocks. In particular, the master NW entity 301 calculates the transmission probability based on at least one of information related to a user density of a geographical region, historical information related to a current coverage region served by the base station, or a QoS requirement of corresponding UEs. The geographical region is a region covered by the field of view (e.g., rural, urban, dense urban, etc.) of the master NW entity 301. The expected user density in the GF access period is considered for the calculation of the transmission probability. The historical information is information about the coverage region currently being served by the satellite. The QoS requirements of UEs can be specified independently for high priority and low priority users in which case, a higher permission probability can be assigned for high priority IoT devices. Further, the transmission probability may be configured for every GF access period for all UEs or a group of UEs.

According to an embodiment of the present disclosure, the master NW entity 301 may periodically set a value of a number of repetitions for each of the UEs or a group of UEs on a set of the allocated CBDT resource blocks and may allow each of the UEs or the group of UEs to access the allocated CBDT resource blocks for the value of the number of repetitions during reception of each of the data bits and the control bits. The value of the number of repetitions is set based on at least one of historical performance data, a current radio conditions at the base station, a decoding failure rate in decoding each of the data bits and the control bits, or transmit power constraints for the UEs. As a non-limiting example, for high user density areas, the number of allowed repetitions can be set as 1. In such a case, a packet can be repeated over a subset of L resource units (RUs) chosen randomly from the set of all RUs available in the grant-free access period. With an increase in a Maximal number of allowed repetitions, L, the reliability of CBDT/GF transmissions can be improved only if collisions are limited. The number of allowed repetitions can also be tuned in conjunction with the transmission probability to achieve a balance between performance and reliability for GF uplink transmissions.

The master NW entity 301 may periodically update the allowed number of repetitions. The master NW entity 301 may also take into account the geographical region (sub-urban, urban, dense-urban) time while determining the number of repetitions on GF resources. The master NW entity 301 may also take into account the user priority order while allocating a different number of maximal repetitions in which case a larger number of repetitions can be allowed for high priority users to provide greater reliability to high priority users.

In accordance with the above-described examples regarding periodically setting the value of the number of repetitions, the master NW entity 301 adjusts the set value of the number of repetitions in conjunction with a transmission probability for each of the plurality of UEs for accessing the allocated CBDT resource blocks, such that a balance between performance and reliability for grant free uplink transmissions is maintained.

For example, in accordance with the above-described methods and the functionalities of the communication system for handling the HARQ and retransmission for shared resources, a seamless user experience for the 6G cellular system can be provided. In particular, in case of the occurrence of contention, the communication system using the described methods can handle the ACK/NACK for the shared resource mechanism seamlessly.

FIG. 8 is a block diagram illustrating an example configuration of the master NW Entity 301 of FIG. 3, according to various embodiments.

In an embodiment, the network entity 800 includes a memory 801, a processor (e.g., including processing circuitry) (803), and a communication interface 805 (e.g., including communication circuitry) (805).

The memory 801 stores a set of instructions required by the processing circuitry of the network entity 800 for controlling its overall operations. The memory 801 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 801 may, in some examples, be considered a non-transitory storage medium. The “non-transitory” storage medium is not embodied in a carrier wave or a propagated signal. However, the term “non-transitory” should not be interpreted that the memory 801 is non-movable. In some examples, the memory 801 can be configured to store larger amounts of information. In certain examples, a non-transitory storage medium may store data that can, over time, change (e.g., in Random Access Memory (RAM) or cache). The memory 801 can be an internal storage unit or it can be an external storage unit of the network entity 800, cloud storage, or any other type of external storage.

The processor 803 may include various processing circuitry and communicates with the memory 801 and the communication interface 805. The processor 803 is configured to execute instructions stored in the memory 801 and to perform various processes. The processor 803 may include one or a plurality of processors, including a general-purpose processor, such as, for example, and without limitation, a central processing unit (CPU), an application processor (AP), a dedicated processor, or the like, a graphics-only processing unit such as a graphics processing unit (GPU), a visual processing unit (VPU), and/or an Artificial intelligence (AI) dedicated processor such as a neural processing unit (NPU).

The communication interface 805 includes various communication circuitry that may include a circuit specific to a standard that enables wired or wireless communication. The communication interface 805 is configured for communicating internally between internal hardware components and with external devices via one or more networks.

Although FIG. 8 illustrates various hardware components of the network entity 800 it is to be understood that the various example embodiments are not limited thereto. In various embodiments, the network entity 800 may include fewer or more number of components. Further, the labels or names of the components are used only for illustrative purpose and does not limit the scope of the disclosure. One or more components can be combined to perform the same or substantially similar function to logical channel management in the wireless network.

FIG. 9 is a block diagram illustrating an example configuration of the UE of FIG. 3, according to various embodiments.

In an embodiment, the UE 900 includes a memory 901, a processor (e.g., including processing circuitry) 903, and a communication interface 905 (e.g., including communication circuitry) 905.

The memory 901 stores instructions to be executed by the processor 903. The memory 901 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 901 may, in some examples, be considered a non-transitory storage medium. The “non-transitory” storage medium is not embodied in a carrier wave or a propagated signal. However, the term “non-transitory” should not be interpreted that the memory 901 is non-movable. In some examples, the memory 901 can be configured to store larger amounts of information. In certain examples, a non-transitory storage medium may store data that can, over time, change (e.g., in Random Access Memory (RAM) or cache). The memory 901 can be an internal storage unit or it can be an external storage unit of the UE 900, cloud storage, or any other type of external storage.

The processor 903 may include various processing circuitry and communicates with the memory 901 and the communication interface 905. The processor 903 is configured to execute instructions stored in the memory 901 and to perform various processes. The processor 903 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communication interface 905 includes various communication circuitry that may include an electronic circuit specific to a standard that enables wired or wireless communication. The communication interface 905 is configured for communicating internally between internal hardware components and with external devices via one or more networks.

Although FIG. 9 illustrates various hardware components of the UE 900 it is to be understood that various example embodiments are not limited thereto. In various embodiments, the UE 900 may include fewer or more number of components. Further, the labels or names of the components are used only for illustrative purpose and does not limit the scope of the disclosure. One or more components can be combined to perform the same or substantially similar function to logical channel management in the wireless network.

As would be apparent to a person in the art, various modifications may be made to the method in order to implement the disclosure as taught herein.

The drawings and the forgoing description give examples of embodiments. Those skilled in the art will appreciate that one or more of the described elements may well be combined into a single functional element. Alternatively, certain elements may be split into multiple functional elements. Elements from an embodiment may be added to another embodiment. For example, orders of processes described herein may be changed and are not necessarily limited to the manner described herein.

Moreover, the actions of any flow diagram need not be implemented in the order shown; nor do all of the acts necessarily need to be performed. Also, those acts that are not dependent on other acts may be performed in parallel with the other acts.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A method for handling contention based data transmission (CBDT) in a wireless communication network by a network entity, comprising:
allocating CBDT resource blocks to a plurality of user equipment (UEs);
receiving, from a group of UEs among the plurality of UEs, data bits and control bits on one or more resource blocks among the allocated CBDT resource blocks;
determining whether each of the received data bits and control bits is decoded successfully;
transmitting a negative acknowledgment message to each UE in the group of UEs based on determining that the received control bits are decoded successfully, and the received data-bits are not decoded successfully; and
storing the received data-bits which are not decoded successfully in a hybrid automatic repeat request (HARQ) buffer.

2. The method of claim 1,
wherein the CBDT resource blocks are allocated to each of the plurality of UEs with a plurality of identifiers, and
wherein the plurality of identifiers includes at least one of a shared radio network temporary identifier (SH RNTI), a contention based data transmission radio network temporary identifier (CBDT RNTI), or an X-CRNTI.

3. The method of claim 2, further comprising:
transmitting, via a radio resource control (RRC) message, the allocated CBDT resource blocks to the plurality of UEs with at least one identifier of the plurality of identifiers;
receiving, from the plurality of UEs, the data bits and control bits of the one or more resource blocks among the allocated CBDT resource blocks in response to the transmitted CBDT resource blocks, wherein each of the received control bits and the data bits is masked with the at least one identifier of the plurality of identifiers; and
identifying, based on the least one identifier with which the received control bits and the data bits are masked, each UE within the group of UEs from which the control bits and the data bits are received.

4. The method of claim 1, further comprising:
transmitting an acknowledgment message to each UE within the group of UEs based on determining that each of the control bits and data-bits is decoded successfully.

5. The method of claim 1,
wherein the negative acknowledgment message includes information related to failed CBDT resource blocks, and
the negative acknowledgment message is transmitted to each UE within the group of UEs via one of a physical control channel or a data channel in form of downlink control information (DCI).

6. The method of claim 1, wherein the method further comprises:
based on the determining that the received data-bits are not decoded successfully, determining whether the decoding of the data bits failed due to at least one of poor radio conditions and an occurrence of contention for accessing a same resource block by at least two UEs of the plurality of UEs; and
transmitting, to each UE within the group of UEs based on determining that the decoding of the data bits failed due to the occurrence of contention, new data bits indicating at least one of a non-requirement of retransmission of the data bits for HARQ process, a recommendation to flush previously transmitted data associated with the HARQ process and subsequently inform upper layers about the flush of the data.

7. The method of claim 6,
wherein the new data bits are transmitted to each UE within the group of UEs via a physical channel including one of a physical channel hybrid ARQ indicator channel (PHICH) or physical downlink control channel (PDCCH), and
wherein the new data bits correspond to broadcast bits.

8. The method of claim 6, further comprising:
toggling, based on determining that the decoding of the data bits failed due to the occurrence of contention, new data indicator (NDI) bit for the HARQ process such that that the previously transmitted data associated with the HARQ process is flushed from the HARQ buffer.

9. The method of claim 8, wherein based on determining that the decoding of the data bits failed due to the poor radio conditions, further comprising:
reallocating the CBDT resource blocks to the plurality of UEs; and
restricting the toggling of the NDI bit for the HARQ process, wherein the reallocated CBDT resource blocks and the allocated CBDT resource blocks are the same.

10. The method of claim 1, further comprising:
periodically calculating, in a grant-free (GF) access period, a transmission probability for each of the plurality of UEs for accessing the allocated CBDT resource blocks; and
transmitting, via a radio resource control (RRC) message, the periodically calculated transmission probability to each of the plurality of UEs together with the allocated CBDT resource blocks.

11. The method of claim 10, wherein the transmission probability for each of the plurality of UEs is periodically calculated based on at least one of information related to a user density of a geographical region, historical information related to a current coverage region served by the base station, or a quality of service (QoS) requirement of corresponding UEs among the plurality of UEs.

12. The method of claim 1, further comprising:
periodically setting a value of a maximum number of repetitions for each of the plurality of UEs or the group of UEs among the plurality of UEs on a set of the allocated CBDT resource blocks; and
allowing, during reception of each of the data bits and the control bits, each of the plurality of UEs or the group of UEs to access the allocated CBDT resource blocks for the value of the maximum number of repetitions.

13. The method of claim 12, wherein the value of the maximum number of repetitions is set based on at least one of historical performance data, a current radio conditions at the base station, a decoding failure rate in decoding each of the data bits and the control bits, or transmit power constraints for the plurality of UEs.

14. The method of claim 12, further comprising:
adjusting the set value of the maximum number of repetitions in conjunction with a transmission probability for each of the plurality of UEs for accessing the allocated CBDT resource blocks, such that a balance between performance and reliability for grant free uplink transmissions is maintained.

15. A network entity for handling contention based data transmission (CBDT) in a wireless communication system, comprising:
a communication interface comprising communication circuitry; and
at least one processor coupled to the communication interface, wherein the at least one processor is configured to:
allocate CBDT resource blocks to a plurality of UEs;
receive, from a group of UEs among the plurality of UEs, data bits and control bits on one or more resource blocks among the allocated CBDT resource blocks;
determine whether each of the received data bits and control bits is decoded successfully;
transmit a negative acknowledgment message to each UE in the group of UEs based on determining that the received control bits are decoded successfully, and the received data-bits are not decoded successfully; and
store the received data-bits which are not decoded successfully in a hybrid automatic repeat request (HARQ) buffer.

16. The network entity of claim 15,
wherein the CBDT resource blocks are allocated to each of the plurality of UEs with a plurality of identifiers, and
wherein the plurality of identifiers includes at least one of a shared radio network temporary identifier (SH RNTI), a contention based data transmission radio network temporary identifier (CBDT RNTI), or an X-CRNTI.

17. The network entity of claim 16, wherein the at least one processor is further configured to:
transmit, in a radio resource control (RRC) message via the communication interface, the allocated CBDT resource blocks to the plurality of UEs with the at least one identifier of the plurality of identifiers;
receive, from the plurality of UEs via the communication interface, the data bits and control bits of the one or more resource blocks among the allocated CBDT resource blocks in response to the transmitted CBDT resource blocks, wherein each of the received control bits and the data bits is masked with the at least one identifier of the plurality of identifiers; and
identify, based on the least one identifier with which the received control bits and the data bits are masked, each UE within the group of UEs from which the control bits and the data bits are received.

18. The network entity of claim 15, wherein the at least one processor is further configured to:
based on the determining that the received data-bits are not decoded successfully, determine whether the decoding of the data bits failed due to at least one of poor radio conditions and an occurrence of contention for accessing a same resource block by at least two UEs of the plurality of UEs; and
transmit, to each UE within the group of UEs via the communication interface based on determining that the decoding of the data bits failed due to the occurrence of contention, new data bits indicating at least one of a non-requirement of retransmission of the data bits for HARQ process, and a recommendation to flush previously transmitted data associated with the HARQ process and subsequently inform upper layers about the flush of the data.

19. The network entity of claim 15, wherein the at least one processor is further configured to:
periodically calculate, in a grant-free (GF) access period, a transmission probability for each of the plurality of UEs for accessing the allocated CBDT resource blocks; and
transmit, via a radio resource control (RRC) message, the periodically calculated transmission probability to each of the plurality of UEs together with the allocated CBDT resource blocks.

20. The network entity of claim 15, wherein the at least one processor is further configured to:
periodically set a value of a maximum number of repetitions for each of the plurality of UEs or the group of UEs among the plurality of UEs on a set of the allocated CBDT resource blocks; and
allow, during reception of each of the data bits and the control bits, each of the plurality of UEs or the group of UEs to access the allocated CBDT resource blocks for the value of the maximum number of repetitions.
